(19) United States
(12) Patent Application Publication
(10) Pub. No.: US 2014/0314393 A1
(43) Pub. Date: Oct. 23, 2014

(54) RECLAIMING STORAGE SPACE ON A PERSONAL VIDEO RECORDER USING SCALABLE VIDEO CODING

(71) Applicants: Gad Moshe Berger, Dayton, NJ (US); Alan Jay Stein, Princeton Junction, NJ (US); Zhenyu Wu, Plainsboro, NJ (US)

(72) Inventors: Gad Moshe Berger, Dayton, NJ (US); Alan Jay Stein, Princeton Junction, NJ (US); Zhenyu Wu, Plainsboro, NJ (US)

(73) Assignee: THOMSON LICENSING a corporation, Issy de Moulineaux (FR)

(21) Appl. No.: 14/356,907

(22) PCT Filed: Dec. 2, 2011
(86) PCT No.: PCT/US2011/063020

§ 371 Date: May 8, 2014

(51) Int. Cl. H04N 5/917; H04N 19/50

(52) U.S. Cl. CPC H04N 5/917; H04N 19/00569
USPC 386/330

(57) ABSTRACT

The present invention concerns a method and associated apparatus for reclaiming storage space on a personal video recorder using scalable video coding. When the personal video recorder reaches a storage threshold, enhancement layers of lower priority recordings may be removed to reduce the storage 5 space required for continued storage of those recordings. Various priority schemes may be utilized to determine which recordings should undergo layer removal, and which layers should be removed.

### BACKGROUND OF THE INVENTION

The present invention generally relates to a method and associated apparatus for reclaiming storage space on a personal video recorder using scalable video coding. When the personal video recorder reaches a storage threshold, enhancement layers of lower priority recordings may be removed to reduce the storage space required for continued storage of those recordings. Various priority schemes may be utilized to determine which recordings should undergo layer removal, and which layers should be removed.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Many modern cable and satellite television set-top boxes provide personal video recorder (PVR) functionality. PVR functionality provides the user with the ability to record programs, as well as pause and rewind programs during viewing. The user will generally interact with an electronic program guide (EPG) to specify which programs are to be recorded. When the specified programs are transmitted to the set-top box at the scheduled time, the data streams of the programs are processed and written to storage in the PVR.

When the PVR storage is near capacity, the recorder must make room to allow recording of new content. A common method of reclaiming storage is to delete the oldest recordings. Recorders may also implement a priority mechanism, where certain programs may be retained regardless of their age, or where programs are retained until programs with lower priority have been removed and space is still required. Other methods allow specified numbers of episodes of a program to be retained, deleting episodes exceeding the specified limit either automatically or when space is needed.

While the methods of reclaiming space may vary, all of the described methods rely upon the deletion of entire recordings. Simple deletion of recordings, however, may negatively impact the user if the user has not yet had the opportunity to view the recordings that are deleted. The invention described herein addresses this and/or other problems.

### SUMMARY OF THE INVENTION

In order to solve the problems described above, the present invention concerns a method and associated apparatus for reclaiming storage space on a personal video recorder using scalable video coding. When the personal video recorder reaches a storage threshold, enhancement layers of lower priority recordings may be removed to reduce the storage space required for continued storage of those recordings. Various priority schemes may be utilized to determine which recordings should undergo layer removal, and which layers should be removed. This and other aspects of the invention will be described in detail with reference to the accompanying Drawings.

### BRIEF DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is a diagram of an exemplary embodiment of a satellite television system;

FIG. 2 is a diagram of a process of removal of enhancement layers from a stored recording.

FIG. 3 is a diagram illustrating metadata related to layers in the stored recording.

FIG. 4 is a flow chart of a process for recovering space through the removal of layers from recorded content.

FIG. 5 is an example of a display of playback options presented to a user for a recording that has undergone a layer removal process.

FIG. 6 illustrates a process by which an enhancement layer from remote storage is combined with a base layer to recreate the original layered recording.

The exemplifications set out herein illustrate preferred embodiments of the invention, and such exemplifications are not to be construed as limiting the scope of the invention in any manner.

### DESCRIPTION OF THE PREFERRED EMBODIMENTS

As described herein, the present invention provides a method and associated apparatus for reclaiming storage space on a personal video recorder using scalable video coding. When the personal video recorder reaches a storage threshold, enhancement layers of lower priority recordings may be removed to reduce the storage space required for continued storage of those recordings. Various priority schemes may be utilized to determine which recordings should undergo layer removal, and which layers should be removed.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The present invention may be implemented in the software or electronics of a satellite or cable television set-top box or other device capable of tuning television signals. The disclosed apparatus and technique may also be used in other signal reception applications.

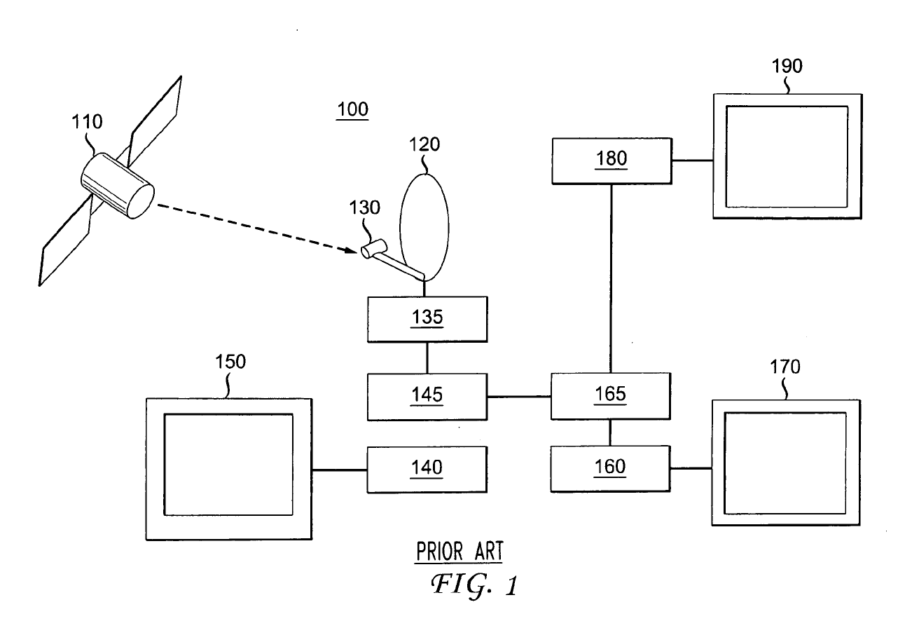

FIG. 1 is a diagram of an exemplary embodiment of a satellite television system. The satellite television system operates to broadcast microwave signals to a wide broadcast area by transmitting the signals from a geosynchronous satellite 110. Satellite 110 receives signals from uplink transmitters and then rebroadcasts the signals back to a satellite-receiving antenna 120 using a set of transponders utilizing a variety of transmission frequencies. The altitude of the transmitting satellite 110 allows subscribers in a wide geographical area to receive the signal.

A low noise block downconverter (LNB) 130 at the feed horn of the parabolic dish antenna 120 amplifies and converts the signal for distribution at the receiving location. In a simple single set-top box configuration, the selected signal from the LNB 130 may travel along a coaxial cable to a digital satellite set-top box 140, which tunes a desired channel for presentation on television display device 150.

Digital set-top box 140 may comprise personal video recorder (PVR) functionality. Generally, a user may interact with a graphical user interface of the set-top box, browse an electronic program guide (EPG), and schedule recordings. PVRs typically store video encoded using the MPEG-2 codec or the H.264 codec, generally storing video using the same encoding used for transmission of the signal. The storage used by the PVR may comprise one or more internal hard drives, one or more external hard drives, internal or external flash memory, or other digital storage.

The digital set-top box 140 may receive signals via a cable infrastructure, over the air, or via a network, in addition to, or in place of, a satellite antenna. In the case of cable, the set-top box may comprise a QAM tuner. In the case of OTA, the set-top box may comprise an ATSC tuner. The PVR may also have a wired or wireless network connection to allow for acquisition of content from the Internet, LAN, or other sources.

When the PVR storage is near capacity, the recorder generally makes room for new content by removing or overwriting old, stale, or low priority content. Recorders also generally implement a priority algorithm to manage conflicts in recording time or recording space. This priority algorithm is used to avoid overwriting content that is valued more highly by the user than the program being received.

Current methods rely upon the deletion of the entirety of each recording selected for removal. This behavior, however, may have negatively impact the user if the user has not yet had the opportunity to view the recordings that are deleted.

To address this problem, a personal video recorder PVR may take advantage of characteristics of an enhanced recording format, such as the Scalable Video Coding (SVC) standard, to increase the lifetime of recorded content. Instead of simply deleting recordings, the recorder may reclaim a portion of the storage space consumed by a recording by removing the enhancement layers of lower priority SVC streams. With SVC, the base layer may be decoded without any enhancement layers and is backwards compatible with the H.264 (AYC) standard. The enhancement layers, however, can only be decoded if they are paired with the base layer and any underlying enhancement layers. Recordings may thus be allowed a longer lifetime on the PVR allowing a user to watch the recording at a later date, albeit at a lower quality level than the original recording.

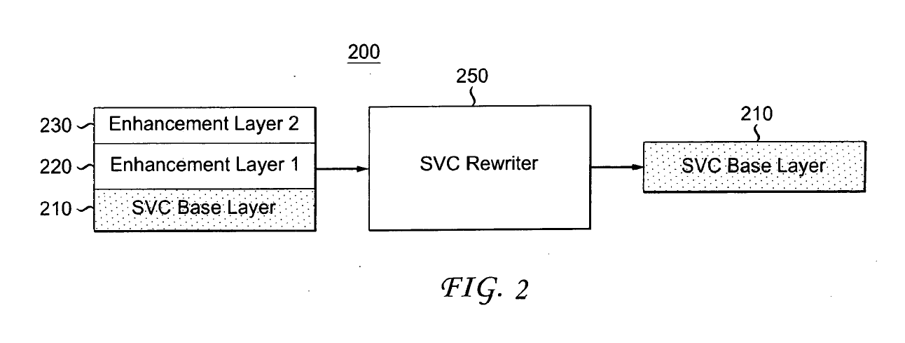

FIG. 2 is a block diagram of a layer removal process 200. An enhanced recording comprising base layer 210 and enhancement layers 220 and 230 is processed by rewriter module 250 to produce a stored recording comprising only base layer 210. In some cases, only certain enhancement layers may be removed, or enhancement layers may be removed in stages, as space is required.

In a system using the SVC standard, the rewriter 250 may be aware of the SVC network abstraction layer (NAL) header syntax and can forward or discard SVC layers as required. The forwarded packets may then be written into a new file. The rewriter may also be required to re-multiplex the video and audio streams.

Each SVC layer has a Dependency, Quality and Temporal ID (DTQ) marker in the SVC NAL header. A change between layers in Dependency ID denotes a change in Course Grain Scalability or Spatial Scalability. A change in Quality ID denotes a change in Medium Grain Scalability. A change in the Temporal ID denotes a change in Temporal Scalability. The base layer 210 has a DTQ of D0, T0 and Q0. In the example of FIG. 2, SVC NAL packets with a DTQ value greater than D0, Q0, and T0 are dropped by rewriter 250.

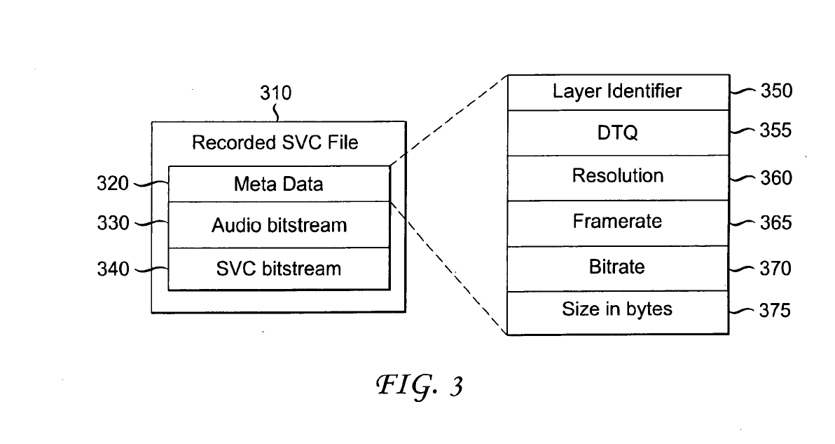

Metadata may be included in the recording file to provide simpler access to information about the layers included in the file. FIG. 3 provides an expanded view of such metadata 320, which may be provided in the recorded file 310 along with the primary video stream 340 and an audio bitstream 330. The metadata may contain multiple elements that may help the PVR decide which SVC enhancement layers to remove. A layer Identifier 350 identifies the layer. The DTQ values 355 may be the same Dependency, Temporal and Quality values that are stored in the SVC NAL header. The resolution 360, framerate 365, bitrate 370, and the size in bytes 375 describe aspects of the video data. The layer identifier 350 may be specific to the PVR implementation and may be numeric or, for instance, classify the layer as “low,” “medium,” or “high” quality.

The resolution 360, frame rate 365, and aggregate bitrate 370 may be used in the layer removal decision process. For instance, the removal algorithm may target layers above a particular resolution or bitrate. The size in bytes 375 of the layer provides an indication of the amount of space that will be gained after removal of the layer. The algorithm may decide which layers to retain based upon the storage requirements and user preferences regarding quality degradation.

The priority of the stored SVC streams may also be determined by other factors including, but not limited to, recording priority, date stamps, whether the stream has been viewed, and whether the program is first-run or second-run. After the enhancement layers are removed, the user will still be able to play the SVC base layer. The resulting video will not carry the same quality as the original recording with all of the enhancement layers, but it will require less space for longer-term retention.

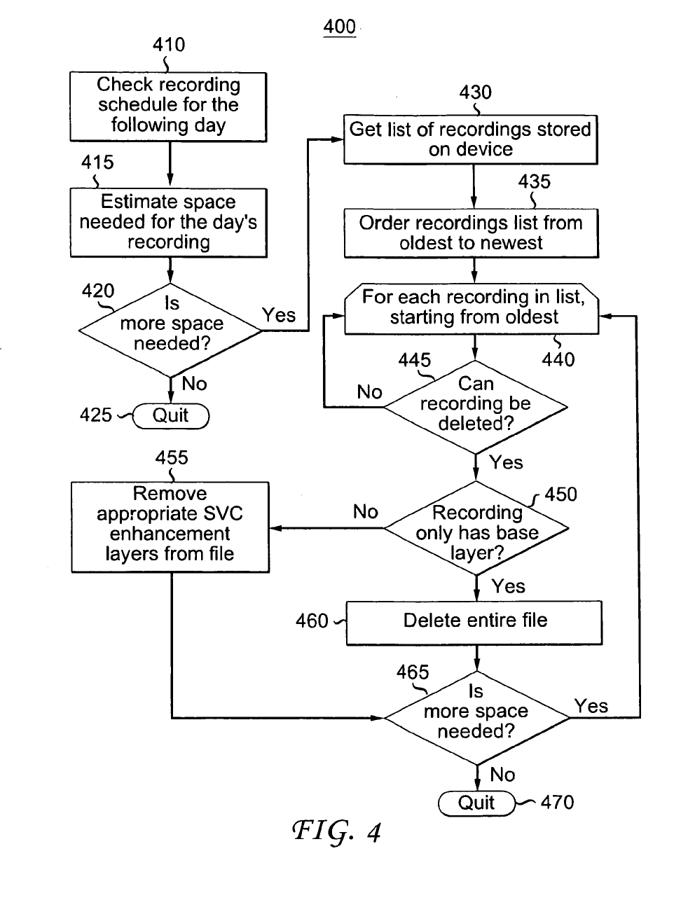

FIG. 4 is a flowchart of one possible process 400 for managing recordings. At step 410, the PVR checks the schedule of upcoming recordings, perhaps for the next hour, day, or multiple days. The space required for the upcoming recordings is determined at step 415. A determination is made at step 420 as to whether additional space is needed to store the programs to be recorded. The calculation of available space may differ significantly from a simple determination of the space reported as available by the storage device or operating system. Space allocated for storage of recordings may be limited for a variety of reasons, including allocation for other functions or for temporary storage for rewriting operations. The space estimate may be based on the lengths of the programs to be recorded and the selected recording quality level. If programs are being recorded prior to or during the pruning process, the recorder must account for the estimated recording size along with the current disk space usage.

If additional space is not needed, the algorithm proceeds to terminal step 425. If additional space is needed, the PVR will proceed to free additional storage space. At step 430, the system assembles a list of stored recordings. In this example, at step 435, the list of recordings is ordered from oldest to newest. Other priority algorithms may be used, as described above. A loop begins at step 440 for traversing the recordings in the determined order. A determination is made at step 445 as to whether the currently considered recording may be deleted. For instance, the recording might be protected for a certain time period or indefinitely based on user preferences. If the recording cannot be deleted, the next recording in the list is considered.

If a recording is a candidate for space reclamation, it may be deleted at step 460 or have enhancement layers removed at step 455, depending on the result of a determination at step 450 as to whether the recording has only a base layer or also includes enhancement layers. If the recording was already trimmed, then it is at the end of its life and may be deleted entirely. Otherwise, it is possible to reduce the size of the recording by removing one or all enhancement layers in the SVC stream. The determination at step 455 may involve analysis of metadata or perhaps analysis of other data indicating that the recording was previously trimmed. If it is determined at step 465 that still more space is needed, the process is repeated for additional recordings, repeating the steps of the loop beginning at step 440. If additional space is not needed, the process terminates at step 470.

It is possible that after all recordings have been considered, particularly if many are protected, that more space will be required. The PVR may then delete remaining non-protected files or cancel recordings. In some variations of the algorithm, the protected recordings from the initial search list may be removed from consideration. The algorithm may also make various intermediate estimates of the space to be gained by removing or trimming the remaining recordings in the list. The removal algorithm may be implemented using a combination of software, firmware, and hardware.

As described earlier, if the enhancement layers are removed to provide space savings, the subjective quality of the video recording is degraded. However, it is possible to recreate the original recording at a later time when space is again available by reinserting the missing enhancement layers. This requires that the enhancement layers be stored in a location accessible external to the recorder, such as at a cable head-end or on an Internet server.

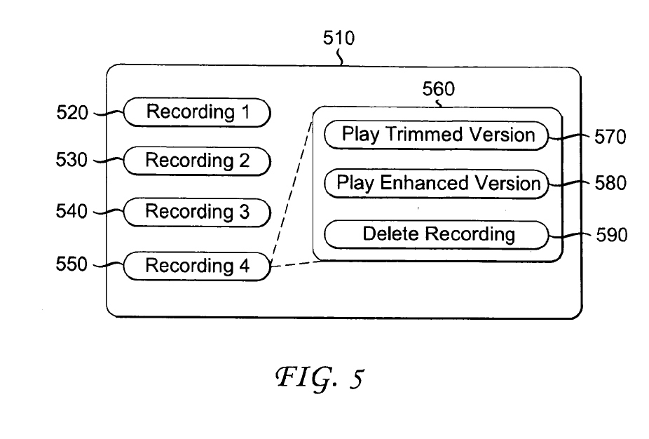

FIG. 5 shows an example of options presented to the user when selecting a recording that has been trimmed to save space. A user interface 510 presents a list of recordings 520, 530, 540, and 550. In this example, the user highlights the fourth recording 550, from which enhancement layers were previously removed. Options 560 are then presented to play the trimmed version 570, play the enhanced version 580, or delete the recording 590. Playback of the trimmed version may be performed from the data on the storage medium. Playing the enhanced version, however, requires combination of the locally available trimmed version and corresponding enhancement layers stored on the external network.

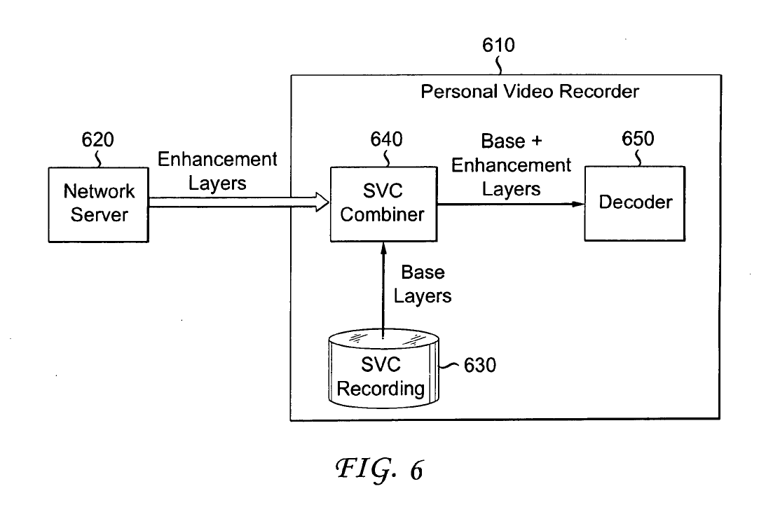

FIG. 6 illustrates a process by which an enhancement layer from a network server 620 is combined by a combiner 640 with the base layer stored in storage 630 of PVR 610 to recreate the original layered recording. The combined stream may then be decoded by decoder 650 or written back to storage 630. The layers may be streamed to the personal video recorder 610 from the network server 620 via a streaming protocol such as RTP or MPEG-2 TS.

In the case of SVC coding, the recorder 610 may read the local SVC-based recording and combine the base layer and enhancement layers in accordance with the ordering required by the SVC standard. The combiner 640 may use the decoding timestamp information that is transmitted by the streaming protocol and stored in the SVC recording storage 630 for each SVC video frame to synchronize the SVC base layer with the streamed enhancement layers.

While the present invention has been described in terms of a specific embodiment, it will be appreciated that modifications may be made which will fall within the scope of the invention. For instance, the technique may be applied to other recording scenarios or to other data formats where non-critical data is stored with core data.

1. A method of managing storage space on a storage medium of a recording apparatus comprising the steps of:
determining a measure of required storage space;
determining a measure of available storage space on said storage medium of said apparatus;
comparing said measure of required storage space with said measure of available storage space; and
responsive to a determination that said measure of required storage space exceeds said measure of available storage space, performing steps comprising:
identifying a recorded program having enhancement layers stored on said storage medium; and
removing at least one of said enhancement layers from said identified recorded program.

2. The method of claim 1 wherein removing said at least one of said enhancement layers comprises:
reading data of said recorded program from storage;
analyzing portions of said data of said recorded program to determine whether each portion is associated with a base layer;
writing portions of said data of said recorded program that are associated with said base layer to storage.

3. The method of claim 1 wherein said step of identifying a recorded program having enhancement layers comprises ordering a list of a plurality of stored recorded programs based upon a priority algorithm.

4. The method of claim 3 wherein said priority algorithm comprises determining the ages of a plurality of stored recorded programs.

5. The method of claim 1 wherein said storage medium comprises at least one of a hard drive or flash memory.

6. The method of claim 1 wherein the data of said recorded program is arranged in accordance with the H.264 Scalable Video Coding standard.

7. The method of claim 1 wherein the step of removing at least one of said enhancement layers comprises determining whether a first enhancement layer is dependent on a second enhancement layer prior to removing said second enhancement layer.

8. The method of claim 1 further comprising the step of removing a recorded program.

9. The method of claim 1 wherein said measure of required storage space is derived from information regarding scheduled recordings.

10. The method of claim 1 further comprising the steps of:
retrieving enhancement layers from a remote storage location; and
combining said retrieved enhancement layers with a corresponding stored program from which enhancement layers had previously been removed.

11. The method of claim 10 further comprising the step of:
presenting said combined recorded program comprising said retrieved enhancement layers.

12. The method of claim 10 wherein said retrieving and combining steps are performed responsive at least to receiving an indication that a user has selected corresponding stored program for viewing.

13. The method of claim 10 wherein said remote storage location is related to a cable head-end or is accessed via the Internet.

14. An apparatus comprising:
a signal receiver;
data storage;
a processor operative to:
determine a measure of required storage space;
determine a measure of available storage space in said data storage;
compare said measure of required storage space with said measure of available storage space; and
responsive to a determination that said measure of required storage space exceeds said measure of available storage space, said processor is further operative to:
identify a recorded program having enhancement layers stored in said data storage; and
remove at least one of said enhancement layers from said recorded program.

15. The apparatus of claim 14 wherein said data storage comprises at least one of a hard drive or flash memory.

16. The apparatus of claim 14 wherein said processor is further operative to:
retrieve enhancement layers from a remote storage location; and
combine said retrieved enhancement layers with a corresponding stored program from which enhancement layers had previously been removed.

17. A television set-top box comprising the apparatus of claim 14.

18. An apparatus comprising:
reception means for receiving transmitted program content;
storage means for storing received program content;
rewriting filter means for removing layers from a recorded program; and
processing means for:
determining a measure of required storage space;
determining a measure of available storage space on said storage means of said apparatus;
comparing said measure of required storage space with said measure of available storage space; and
responsive to a determination that said measure of required storage space exceeds said measure of available storage space, performing steps comprising:
identifying a recorded program having enhancement layers stored on said storage means; and
causing said rewriting filter means to remove at least one of said enhancement layers from said recorded program.

19. The apparatus of claim 18 wherein said reception means comprise at least one of satellite television receiving means, QAM tuning means, or ATSC tuning means.

20. A television set top box comprising the apparatus of claim 18.
